(19) United States
(12) Patent Application Publication
(10) Pub. No.: US 2022/0363067 A1
(43) Pub. Date: Nov. 17, 2022

(54) PRINTING SYSTEM

(71) Applicant: SEIKO EPSON CORPORATION, Tokyo (JP)

(72) Inventor: Shinya YAMAGATA, Matsumoto-shi (JP)

(73) Assignee: SEIKO EPSON CORPORATION, Tokyo (JP)

(21) Appl. No.: 17/744,938

(22) Filed: May 16, 2022

(30) Foreign Application Priority Data
May 17, 2021 (JP) 2021-083257

(51) Int. Cl. B41J 2/175

(52) U.S. Cl. CPC B41J 2/17546; B41J 2/1752

(57) ABSTRACT

A printing system includes a printer and a cartridge to be attached to the printer in a replaceable manner. The cartridge includes a storage section storing identification information corresponding to an assumed user group assumed to use the cartridge. The printer is configured to perform print setting, and the print setting is performed in accordance with the identification information in the storage section in a state in which the cartridge is attached to the printer.

The present application is based on, and claims priority from JP Application Serial Number 2021-083257, filed May 17, 2021, the disclosure of which is hereby incorporated by reference herein in its entirety.

### BACKGROUND

### 1. Technical Field

The present disclosure relates to a printing system.

### 2. Related Art

Printers to be set in accordance with a use area are on the market. In the technique in JP-A-2006-323508, a printer includes a GPS unit. When the printer is coupled to a personal computer, the printer obtains location information by using the GPS unit. Based on the location information, the personal computer refers to a country identification table and a country information table that are held in the personal computer and identifies a destination group of the printer. The destination group is saved in the memory of the personal computer.

At the time of printing, the paper types and the paper sizes in accordance with a destination group saved in the memory of the personal computer are presented to a user, and the user selects them. In addition, the parameters in accordance with the destination group saved in the memory of the personal computer are read, and the personal computer performs color correction processing in accordance with the parameters. Next, printing is performed. With this technique, a printing environment suitable for an area in which the printer is used is realized.

However, in the technique in JP-A-2006-323508, a printer to be used for printing must be coupled to a personal computer. Accordingly, for example, for a printer that is not coupled to a personal computer and is used as a standalone unit, for example, a printer used for a facsimile or a copy machine, it is not possible to realize a printing environment in accordance with an area in which the printer is used. In addition, in the technique in JP-A-2006-323508, a printer has to include a GNSS (Global Navigation Satellite System) unit, such as a GPS unit, or the like.

### SUMMARY

According to an aspect of the present disclosure, there is provided a printing system. The printing system includes a printer and a cartridge to be attached to the printer in a replaceable manner. The cartridge includes a storage section storing identification information corresponding to an assumed user group assumed to use the cartridge. The printer is configured to perform print setting, and the print setting is performed in accordance with the identification information in the storage section in a state in which the cartridge is attached to the printer.

### BRIEF DESCRIPTION OF THE DRAWINGS

FIG. 1 is a perspective view illustrating a main section of a printing system according to a first embodiment.

FIG. 2 is an external perspective view of an ink cartridge.

FIG. 3 is a block diagram illustrating the functional blocks of a printer and the ink cartridge.

FIG. 4 is a conceptual diagram illustrating a specification table.

FIG. 5 is a flowchart illustrating print setting processing.

FIG. 6 is a table illustrating the results of the processing in steps S310 and S320 in FIG. 5.

FIG. 7 is a flowchart illustrating print setting processing according to a second embodiment.

FIG. 8 is a conceptual diagram illustrating a specification table according to a third embodiment.

FIG. 9 is a flowchart illustrating print setting processing according to the third embodiment.

### DESCRIPTION OF EXEMPLARY EMBODIMENTS

### 1. First Embodiment

### 1.1 Configuration of Printing System

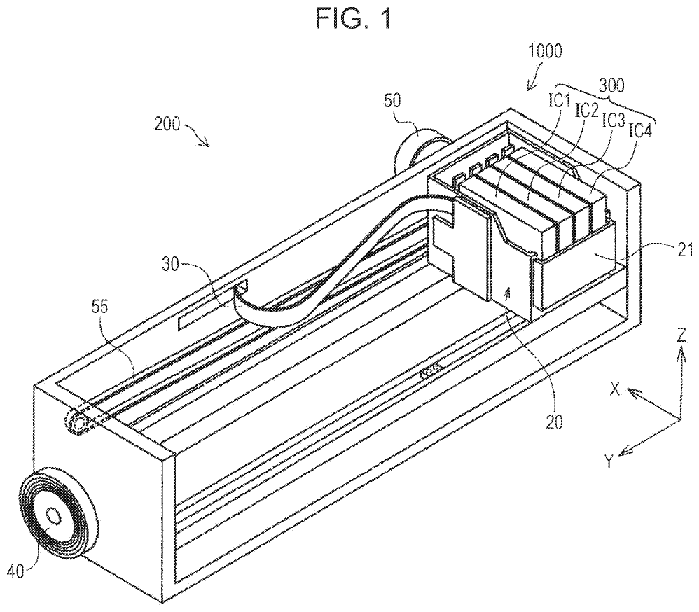

FIG. 1 is a perspective view illustrating a main section of a printing system 1000 according to the present embodiment. The printing system 1000 includes a printer 200 and an ink cartridge 300. FIG. 1 illustrates the X-axis, Y-axis, and Z-axis that are coordinate axes perpendicular to each other. In the printer 200 placed on a horizontal plane, the negative Z-axis direction is a vertical downward direction. The horizontal plane is a plane parallel to the X-axis direction and the Y-axis direction. In order to facilitate a technological understanding, some parts of elements of the printer 200 are not illustrated in FIG. 1.

The printer 200 is a printer that is not coupled to a personal computer and is used as a facsimile in a so-called stand-alone mode. The printer 200 includes a carriage 20, a cable 30, a paper feed motor 40, a paper feed roller, a carriage motor 50, a carriage drive belt 55, and a controller 210. In this regard, in order to facilitate a technological understanding, the paper feed roller and the controller 210 are not illustrated in FIG. 1.

The carriage 20 is driven by the carriage motor 50 via the carriage drive belt 55 and is reciprocated in the Y-axis direction. The carriage 20 is coupled to the controller 210 via the cable 30. The carriage 20 includes a holder 21 and a print head.

The holder 21 accommodates ink cartridges IC1 to IC4 in a detachable manner. That is to say, the ink cartridges IC1 to IC4 are attached to the printer 200 via the holder 21 of the printer 200 in a replaceable manner. The holder 21 includes four liquid supply needles and a plurality of device side terminals, which are not illustrated in FIG. 1.

The four liquid supply needles are inserted into the respective ink cartridges IC1 to IC4 and distribute ink from the respective ink cartridges IC1 to IC4 to the corresponding print heads. The ink cartridges IC1 to IC4 each contain ink of a respective color. Each ink cartridge is typically detached from the printer 200 when the contained ink is exhausted. The ink cartridges are so-called consumables. In this regard, it is possible to detach, as necessary, an ink cartridge from the printer 200 before the contained ink is exhausted, for example, when the other ink is used, or the like.

The plurality of device side terminals are disposed inside the holder 21. The ink cartridges IC1 to IC4 each include a plurality of substrate terminals. The plurality of device side terminals of the holder 21 come into contact with the corresponding substrate terminals of the ink cartridges IC1 to IC4 in a state in which the ink cartridges IC are attached to the printer 200. As a result, the circuit substrates of the ink cartridges IC1 to IC4 are electrically coupled to the controller 210 of the printer 200.

The print heads are disposed on the faces of the carriage 20 at the negative Z-axis direction side. Ink supplied from the ink cartridges IC1 to IC4 is discharged from the print heads onto a recording medium. The discharge of ink from the print head is controlled by the controller 210.

The paper feed motor 40 rotates the paper feed roller and transports the recording medium in the negative X-axis direction. The carriage motor 50 drives the carriage drive belt 55 to move the carriage 20 bidirectionally in the Y-axis direction. The paper feed, the movement of the carriage 20, and the discharge of ink are controlled by the controller 210 so that the printer 200 performs printing.

### 1.2 Configuration of Ink Cartridge

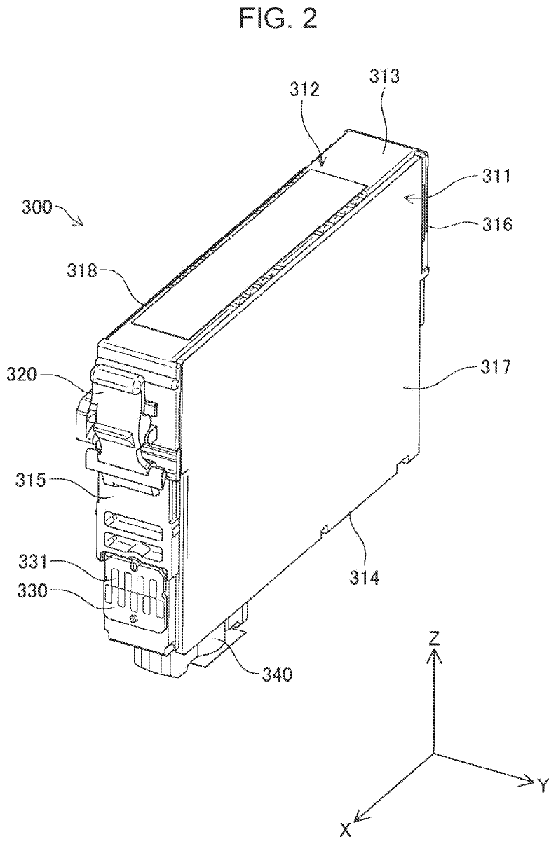

FIG. 2 is an external perspective view of the ink cartridge 300. The X-axis, Y-axis, and Z-axis illustrated in FIG. 2 correspond to the X-axis, Y-axis, and Z-axis illustrated in FIG. 1, respectively. In the present specification, when the ink cartridges IC1 to IC4 are expressed without distinction, they are collectively referred to as the ink cartridge 300.

The outer shape of the ink cartridge 300 is substantially cuboidal. The outer surface, that is to say, the outer shell of the ink cartridge 300 includes six faces. The six faces are a bottom face 314, an upper face 313, a front face 315, a back face 316, a right-side face 317, and a left-side face 318. The outer surface of the ink cartridge 300 includes a film forming a part of the left-side face 318, a container body 312, and a cover member 311. In this specification, a state in which ink cartridges IC are attached to the printer 200 placed on a horizontal plane is referred to as an “attached state”.

A liquid supply section 340 is disposed on the bottom face 314 in a protruding manner. On the end face of the liquid supply section 340, a supply opening for distributing ink inside the ink cartridge 300 to the outside is formed. The liquid supply needles disposed on the holder 21 of the printer 200 are inserted into the supply opening. By inserting the liquid supply needles into the supply opening, the ink cartridge 300 is coupled to the holder 21.

A circuit substrate 330 is disposed at a position nearer to the bottom face 314 than to the upper face 313 on the front face 315 (refer to the lower left part in FIG. 2). A plurality of substrate terminals 331 are formed on the front face of the circuit substrate 330. Each of the plurality of substrate terminals 331 comes into contact with a corresponding one of the plurality of device side terminals disposed on the holder 21 of the printer 200 in the attached state. As a result, the circuit substrate 330 is electrically coupled to the controller 210 of the printer 200. In addition, a rewritable semiconductor memory 352 is disposed on the back side of the circuit substrate 330. The semiconductor memory 352 stores identification information Di indicating the ink destination, the color of the ink contained in the ink cartridge 300, the consumption or the remaining amount, and other information on the ink cartridge 300. In this regard, the semiconductor memory 352 is located on the back side of the circuit substrate 330 and is thus not illustrated in FIG. 2.

A lever 320 is disposed at a position nearer to the upper face 313 than the circuit substrate 330 on the front face 315. The lever 320 is elastically deformed for use during attaching and detaching of the ink cartridge 300 to and from the printer 200.

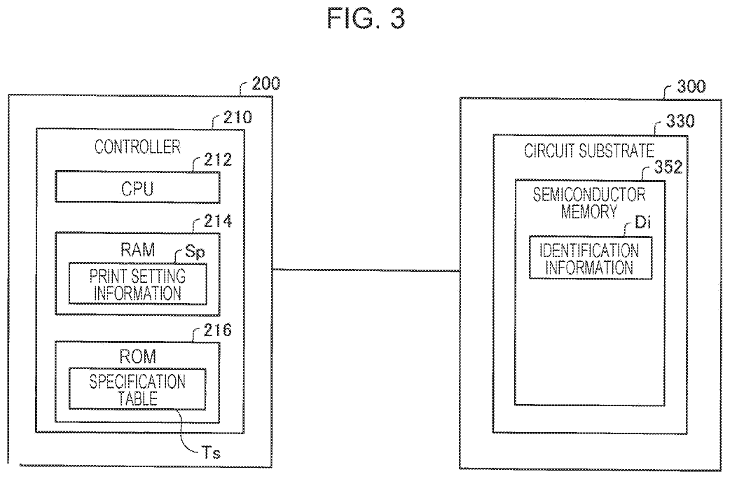

FIG. 3 is a block diagram illustrating the functional blocks of the printer 200 and the ink cartridge 300. As described above, the semiconductor memory 352 of the ink cartridge 300 stores the identification information Di (refer to the middle right part in FIG. 3). The identification information Di is information corresponding to an assumed user group that is assumed to use the ink cartridge 300. In the present embodiment, the identification information Di is set in accordance with an area where the ink cartridge 300 is sold, a so-called “destination”. Destinations include, Japan, Asia excluding Japan, North America, South America, Europe, Africa, and the like. Each destination is set in accordance with an environment in which a printer is used, a language used in the land, a print medium used in the land, and the like. In the present specification, an assumed user group set in accordance with the destination is also referred to as a “destination group”. The identification information Di is specifically a number assigned to each destination group.

The controller 210 of the printer 200 is a computer including a CPU (central processing unit) 212, which is a processor, a RAM (random access memory) 214, and a ROM (read-only memory) 218. The CPU 212 loads a computer program stored in the ROM 216 to the RAM 214 and executes the program so as to realize various functions described later.

The ROM 216 stores a specification table Ts. The specification table Ts includes a plurality of operation specifications of the printer 200. The plurality of operation specifications are determined in accordance with the respective assumed user groups.

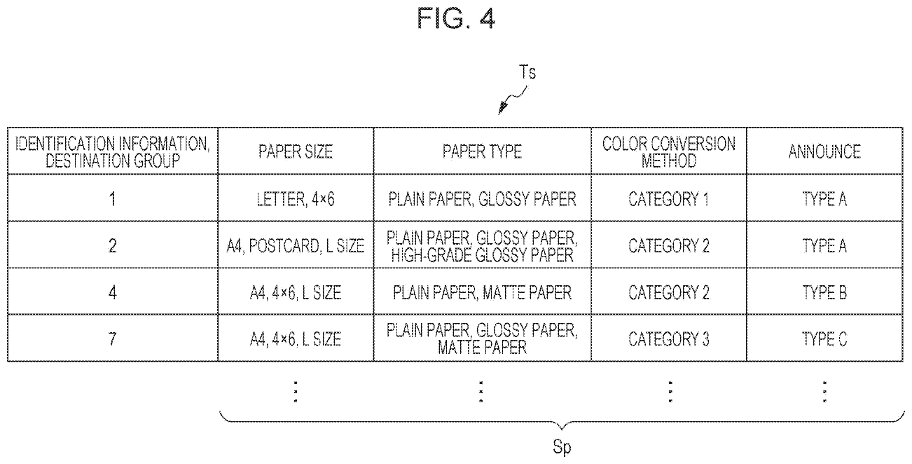

FIG. 4 is a conceptual diagram illustrating the specification table Ts. The operation specification includes paper size information, paper type information, information on a color conversion method, and announce information. The paper size and the paper type are the parts of the setting conditions set at the time of print setting. Information on a color conversion method is a parameter group that determines the characteristic of color conversion at the time of print execution. Announce information represents the language and the contents of a message output to a user via a user interface screen of the printer 200, which is not illustrated in FIG. 1. Paper size information, paper type information, information on a color conversion method, and announce information is collectively referred to as “print setting information Sp”. These pieces of information are determined for each destination group.

The printer 200 is configured to perform different print settings in accordance with the corresponding assumed user groups, more specifically, the destinations indicated by the identification information Di. The controller 210 of the printer 200 performs print setting in accordance with the identification information Di in the semiconductor memory 352 in a state in which the ink cartridge 300 is attached to the printer 200. The specification table Ts in the ROM 216 of the printer 200 is referenced when the print setting in accordance with the identification information Di is performed.

### 1.3 Print Setting Processing

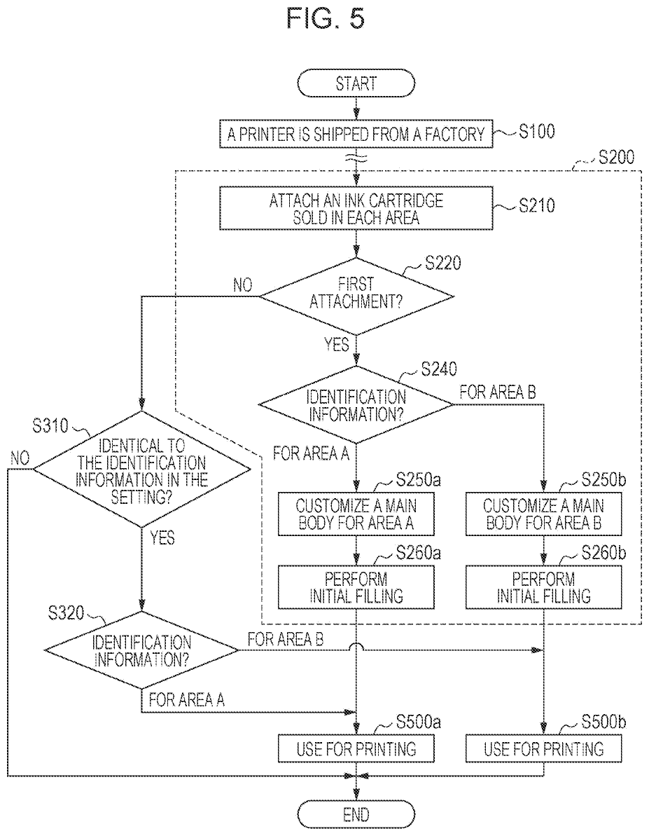

FIG. 5 is a flowchart illustrating the print setting processing. In step S100, a printer 200 is shipped from a factory.

Next, in step S200, the controller 210 of the printer 200 performs print setting in accordance with the identification information Di in the semiconductor memory 352 and performs initial filling. Other processing might be performed between step S100 and step S200. Step S200 includes steps S210 to S240, S250a, S260a, S250b, and S260b.

In step S210, the user attaches an ink cartridge 300 that is sold in the area in which the printer 200 is used and that has been purchased by the user in advance to the printer 200. As a result, the substrate terminal of the ink cartridge 300 is coupled to the device side terminal of the printer 200. When the substrate terminal and the device side terminal are electrically coupled, the controller 210 of the printer 200 detects attachment of the ink cartridge 300 to the holder 21. The controller 210 reads the identification information Di from the semiconductor memory 352 of the ink cartridge 300 (refer to FIG. 3).

In step S220 in FIG. 5, the controller 210 determines whether or not attachment of the detected ink cartridge 300 is the first attachment of the ink cartridge 300 to the printer 200. When attachment of the detected ink cartridge 300 is not the first attachment of the ink cartridge 300 to the printer 200, the processing proceeds to step S310. When attachment of the detected ink cartridge 300 is the first attachment of the ink cartridge 300 to the printer 200, the processing proceeds to step S240.

In step S240, the controller 210 determines whether the information indicated by the identification information Di is for area A or for area B. In this regard, in the example in FIG. 5, a description will be given on the assumption that the classification of the destination involves only two items in order to facilitate a technological understanding. When the information indicated by the identification information Di is area A, the processing proceeds to step S250a. When the information indicated by the identification information Di is area B, the processing proceeds to step S250b.

In step S250a, based on the information on area A indicated by the identification information Di, the controller 210 refers to the specification table Ts in the ROM 216 and reads paper size information, paper type information, information on the color conversion method, and announce information (refer to FIG. 4). The controller 210 performs print setting of the printer 200 by using the print setting information Sp. As a result, the paper size information, the paper type information, the information on the color conversion method, and the announce information are stored in the RAM 214 of the printer 200. The controller 210 operates the printer 200 by using the paper size information, the paper type information, the information on the color conversion method, and the announce information in the RAM 214. That is to say, the print setting is performed in accordance with the identification information Di read first from the semiconductor memory 352 of the ink cartridge 300 attached to the printer 200. As a result, the destination of the printer 200 is determined, and the printer 200 becomes able to perform the operation suitable for each destination. In FIG. 3, the paper size information, the paper type information, the information on the color conversion method, and the announce information in the RAM 214 are referred to as print setting information Sp.

In step S260a in FIG. 5, the controller 210 performs initial filling. Specifically, a print head is covered with a cap, and the air in the cap is absorbed so that the ink in the ink cartridge 300 is guided to a nozzle of the print head located at the end in an ink supply path. By the above processing, the printer 200 becomes a printable state.

In step S500a, the printer 200 is used for printing by the user. The controller 210 controls each section of the printer 200 in response to an instruction from the user to perform printing. The processing of steps S260a and S500a is performed in accordance with the setting performed in step S250a.

On the other hand, in step S250b, based on the information on area B indicated by the identification information Di, the controller 210 refers to the specification table Ts in the ROM 216 and reads paper size information, paper type information, information on the color conversion method, and announce information (refer to FIG. 4). The controller 210 performs the setting of the printer 200 by using the information. The processing in step S250b is the same as the processing in step S250a except for the point that the processing is performed in accordance with the information on the area B indicated by the identification information Di.

The processing in steps S260b and S500b is the same as the processing in steps S260a and S500a, respectively, except for the point that the processing is performed in accordance with the setting performed in step S250b.

On the other hand, in the processing of step S310 and after that, the controller 210 does not perform print setting in accordance with the identification information Di stored in the semiconductor memory 352. That is to say, when the identification information Di is read from the semiconductor memory 352 of the ink cartridge 300 attached to the printer 200 from the second time onwards, the print setting in accordance with the identification information Di is not performed (refer to S220 in FIG. 5).

By performing such processing, when the user mistakenly attaches, to the printer 200, an ink cartridge 300 that is not sold in the area after having started to use the printer 200, the print setting of the printer 200 will not be overwritten. In step S310 and the subsequent steps, the following processing is specifically performed.

In step S310, the controller 210 determines whether or not the identification information Di in the semiconductor memory 352 of a new ink cartridge 300, which was obtained in step S210, is the identification information Di corresponding to the same print setting as the print setting already made for the printer 200. When the identification information Di in the semiconductor memory 352 of the new ink cartridge 300 is the identification information Di corresponding to the same print setting as the print setting already made, the processing proceeds to step S320. Such a case is, for example, a case in which the identification information Di in the semiconductor memory 352 of the new ink cartridge 300 corresponds to Japan, and the destination in the print setting already made is a setting corresponding to Japan.

When the identification information Di in the semiconductor memory 352 of the new ink cartridge 300 is not the identification information Di corresponding to the same print setting as the print setting already made, the processing in FIG. 5 ends. Such a case is, for example, a case in which the identification information Di in the semiconductor memory 352 of the new ink cartridge 300 corresponds to Japan, and the destination in the print setting already made is a setting corresponding to North America.

That is to say, when a new ink cartridge 300 is attached to the printer 200 in a state in which the print setting is already made, and the identification information Di in the semiconductor memory 352 of the new ink cartridge 300 is different from the print setting Sp already made, the processing ends. Accordingly, in such a case, printing is not performed in a state in which the new ink cartridge 300 is attached to the printer 200.

In step S320, the controller 210 determines whether the destination indicated by the identification information Di is area A or area B. When the destination is area A, the processing proceeds to step S500a. When the destination is area B, the processing proceeds to step S500b.

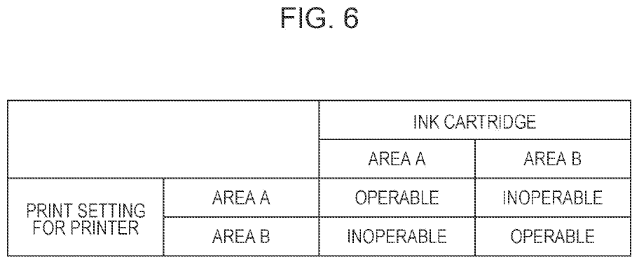

FIG. 6 is a table indicating the results of the processing in steps S310 and S320 in FIG. 5. When the print setting in the printer 200 corresponds to area A, and the identification information Di of an ink cartridge 300 attached to the printer 200 corresponds to area A, it is possible for the printer 200 to perform operation in combination with the ink cartridge 300. On the other hand, when the print setting in the printer 200 corresponds to area A, and the identification information Di of an ink cartridge 300 attached to the printer 200 corresponds to area B, it is not possible for the printer 200 to perform operation in combination with the ink cartridge 300.

In the same manner, when the print setting in the printer 200 corresponds to area B, and the identification information Di of an ink cartridge 300 attached to the printer 200 corresponds to area B, it is possible for the printer 200 to perform operation in combination with the ink cartridge 300. On the other hand, when the print setting in the printer 200 corresponds to area B, and the identification information Di of an ink cartridge 300 attached to the printer 200 corresponds to area A, it is not possible for the printer 200 to perform operation in combination with the ink cartridge 300.

By performing such processing, it is possible to prevent the situation in which printing is performed by using an ink cartridge 300 for a destination different from the destination of the ink cartridge 300 assumed in print setting made in the printer 200, and low-quality printed material is generated.

By performing the above processing, when the printer 200 is not coupled to a personal computer, it is possible to make a print setting for the printer 200 in accordance with an assumed user group, which is assumed as a user, more specifically, a user group corresponding to its destination. That is to say, in the stage of shipment from a factory (refer to S100 in FIG. 5), it is not necessary for the printer 200 to have a specification suitable for each destination, and thus it is possible to unify the specification of all the printers 200. Accordingly, it becomes easy to manage the supply of the printer 200. The print setting is made in accordance with an ink cartridge prepared and distributed for each area in the world with a different specification, and thus print setting suitable for the actual use place is made for the printer 200. In addition, in this processing, it is not necessary for the printer 200 to include a GNSS (Global Navigation Satellite System) unit, such as a GPS unit, or the like.

The ink cartridge 300 in the present embodiment is also referred to as a “cartridge”. The semiconductor memory 352 in the present embodiment is also referred to as a “storage section”.

### 2. Second Embodiment

In a second embodiment, the printer 200 is shipped from a factory with an ink cartridge 300b having the semiconductor memory 352 that does not store identification information Di. The ink cartridge 300b is attached to the printer 200 for the first time. Accordingly, the print setting processing in the second embodiment is different from the print setting processing in the first embodiment. The other configuration in the second embodiment is the same as that of the first embodiment.

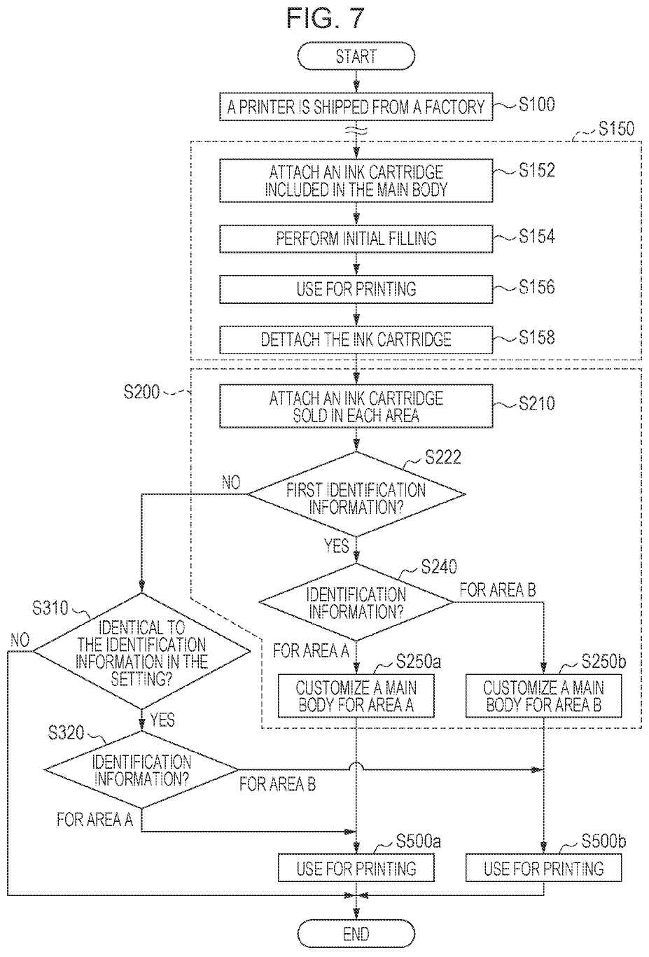

FIG. 7 is a flowchart illustrating the print setting processing according to the second embodiment. In the print setting processing in the second embodiment, the processing of step S150 is performed between step S100 and step S200 in FIG. 5. In the step S200, instead of the processing of step S220, the processing of step S222 is performed. In addition, the processing of steps S260a and S260b is not performed. The other points in the print setting processing according to the second embodiment are the same as those of the print setting processing according to the first embodiment.

In step S150, the controller 210 of the printer 200 does not perform the print setting in accordance with the identification information Di in the semiconductor memory 352, but performs initial filling. Step S150 includes steps S152, S154, S156, and S158.

In step S152, the user attaches an ink cartridge 300b shipped from a factory with the printer 200 to the printer 200. As a result, the substrate terminal of the ink cartridge 300b is coupled to the device side terminal of the printer 200. When the substrate terminal and the device side terminal are electrically coupled, the controller 210 of the printer 200 detects that the ink cartridge 300b is attached to the holder 21. However, the semiconductor memory 352 of the attached ink cartridge 300b does not store identification information Di. Accordingly, the controller 210 of the printer 200 does not read the identification information Di (refer to FIG. 3).

In step S154 in FIG. 7, the controller 210 performs initial filling. The contents of the processing in step S154 are the same as those of the processing in step S260a in FIG. 5. By performing the above processing, it becomes possible for the printer 200 to perform printing. However, in the printer 200, the print setting in accordance with a destination has not been performed.

In step S156, the user uses the printer 200 for printing. The controller 210 controls each section of the printer 200 in response to an instruction from the user to perform printing. The processing of steps S154 and S156 is performed in a state in which the print setting in accordance with a destination has not been performed.

In step S158, the user detaches the ink cartridge 300b shipped from a factory with the printer 200 from the printer 200.

After the processing in step S150, the processing of step S200 is performed. The processing of step S210 is the same as the processing of step S210 in FIG. 5. That is to say, in step S210, the user attaches an ink cartridge 300, which is sold in the area where the printer 200 is used and which has been purchased in advance to the printer 200. As a result, the controller 210 of the printer 200 reads the identification information Di from the semiconductor memory 352 of the ink cartridge 300 (refer to FIG. 3).

In step S222, the controller 210 determines whether or not the identification information Di read in step S210 is the identification information Di read from the semiconductor memory 352 of the ink cartridge 300 attached to the printer 200 for the first time. When the read identification information Di is not the identification information Di read from the semiconductor memory 352 of the ink cartridge 300 attached to the printer 200 for the first time, the processing proceeds to step S310. When the read identification information Di is the identification information Di read from the semiconductor memory 352 of the ink cartridge 300 attached to the printer 200 for the first time, the processing proceeds to step S240.

The processing of steps S240, S250a, and S250b in FIG. 7 is the same as the processing of steps S240, S250a, and S250b in FIG. 5, respectively. However, after step S250a, the processing of step S260a in FIG. 5 is not performed, and the processing proceeds to step S500a. In the same manner, after step S250b, the processing step S260b in FIG. 5 is not performed, and the processing proceeds to step S500b.

With the second embodiment, the same advantages as those of the first embodiment are obtained. That is to say, when the printer 200 is not coupled to a personal computer, it is possible to cause the printer 200 to perform the print setting in accordance with an assumed user group assumed to be a user, more specifically, in accordance with a user group corresponding to a destination. In addition, in the second embodiment, it is not necessary for the printer 200 to include a GNSS unit, such as a GPS unit, or the like.

### 3. Third Embodiment

In a third embodiment, an ink cartridge 300c contains the ink adjusted in response to a request from a specific user Us. Among the many ink cartridges attachable to the printer 200 and distributed, the ink cartridge 300c that contains the ink is sold only to the specific user Us. The identification information Di stored in the semiconductor memory 352 of the ink cartridge 300c is the information corresponding to the specific user Us. Accordingly, the processing for the print setting according to the third embodiment is different from the processing for the print setting according to the first embodiment. The other points of the configuration in the third embodiment are the same as those of the configuration according to the first embodiment.

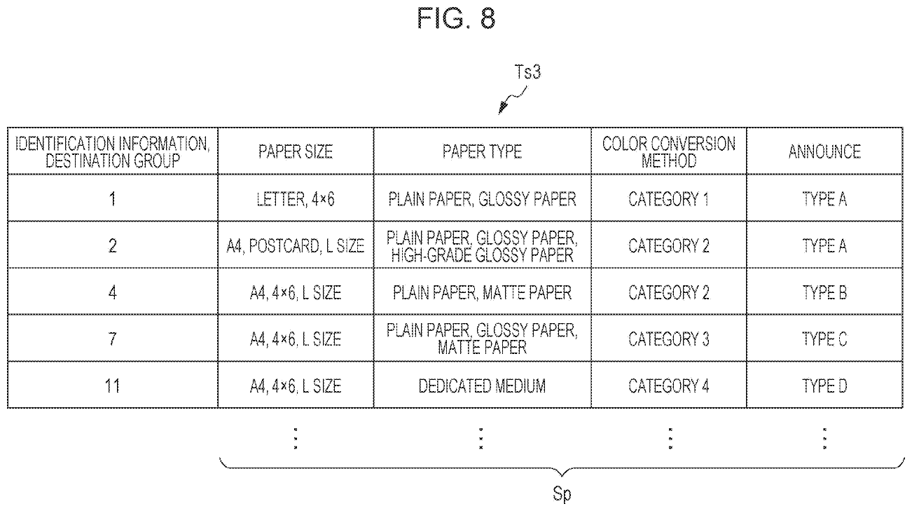

FIG. 8 is a conceptual diagram illustrating a specification table Ts3 according to the third embodiment. The specification table Ts3 includes the paper size information, the paper type information, the information on the color conversion method, and the announce information determined in accordance with the ink for the user Us in addition to the information included in the specification table Ts according to the first embodiment (refer to the lower part of FIG. 8). In the example in FIG. 8, the destination group number corresponding to the user Us is 11. The paper type is a dedicated medium. The color conversion method is category 4. The announce is type D.

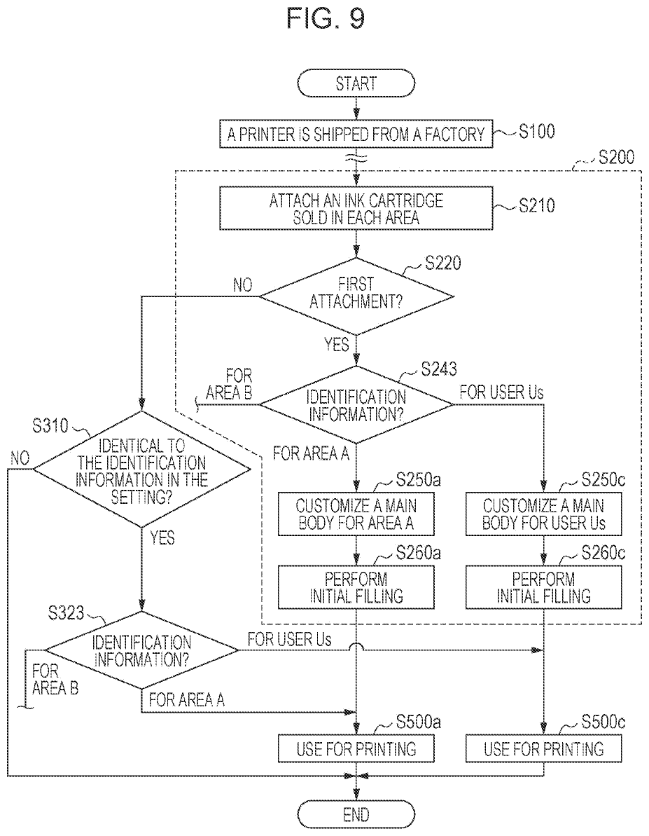

FIG. 9 is a flowchart illustrating the print setting processing according to the third embodiment. In the print setting processing according to the third embodiment, the processing of steps S243 and S323 is performed instead of the processing of steps S240 and S320 in FIG. 5, respectively. In addition, in the print setting processing according to the third embodiment, the processing of steps S250c, S260c, and S500c is performed in addition to the processing in FIG. 5. The other configuration of the print setting processing according to the third embodiment is the same as that of the print setting processing according to the first embodiment. However, in order to facilitate a technological understanding, the illustration of steps S250b, S260b, and S500b is omitted in FIG. 9 (refer to steps S243 and S323).

In step S243, the controller 210 determines whether the information indicated by the identification information Di is area A, area B, or user Us. When the information indicated by the identification information Di is area A, the processing proceeds to step S250a. When the information indicated by the identification information Di is area B, the processing proceeds to step S250b. When the information indicated by the identification information Di is user Us, the processing proceeds to step S250c.

The processing in steps S250a and 250b is the same as the processing in steps S250a and 250b according to the first embodiment, respectively, except for the point that the processing is performed with reference to the specification table Ts3 in the ROM 216.

The processing in steps S260a, S500a, S260b, and S500b is the same as the processing in steps S260a, S500a, S260b, and S500b according to the first embodiment, respectively.

In step S250c, based on the information on the user Us indicated by the identification information Di, the controller 210 refers to the specification table Ts3 in the ROM 216 and reads the paper size information, the paper type information, the information on the color conversion method, and the announce information (refer to FIG. 8). The controller 210 performs the setting of the printer 200 by using the information. The processing in step S250c is the same as the processing in step S250a except for the point that the processing is performed in accordance with the information of the user Us, which is indicated by the identification information Di.

The processing in steps S260c and S500c is the same as the processing in steps S260a and S500a, respectively, except for the point that the processing is performed in accordance with the setting made in step S250c.

By performing such processing, when an ink cartridge 300c containing the ink adjusted in response to a request from a specific user Us is sold only to the specific user Us, the print setting in accordance with the adjusted ink of the ink cartridge 300c is performed for the printer 200.

### 4. Other Embodiments

### 4.1 Other First Embodiment

(1) In the above embodiments, the identification information Di is stored in the semiconductor memory 352 of the ink cartridge 300 (refer to the middle right part in FIG. 3). However, a part of the components of the cartridge may have a shape in accordance with the identification information, and the identification information may be saved in the cartridge as a part of the shape of the cartridge.

(2) In the above embodiments, the print setting is performed by referring to the specification table Ts in the ROM 216 (refer to the lower left part in FIG. 3). However, the print setting may be performed by referring to the other information. For example, the print setting may be performed by referring to data including plural kinds of print setting information stored in a memory card inserted into the card slot of the printer. That is to say, it is possible to perform the print setting, for example, by referring to plural kinds of print setting information provided in some way, such as a mode in which the printer holds plural kinds of print setting information in advance, a mode in which plural kinds of print setting information is provided to the printer from the outside, or the like. In addition, a part of the print setting may be made based on the input by a user via the user interface of the printer.

(3) In the above embodiments, the controller 210 sets the paper size information, the paper type information, the information on the color conversion method, and the announce information for the printer 200 based on the identification information Di (refer to FIG. 4). However, the information set for the printer based on the identification information is not limited to this, and the other information, such as the parameter of halftone processing, or the like may be included.

(4) In the above embodiments, in step S310, the controller 210 determines whether or not the identification information Di in the semiconductor memory 352 of a new ink cartridge 300 is the identification information Di corresponding to the same print setting as the print setting already made (refer to the middle left part in FIG. 5). However, the processing in steps S310 and S320 may be configured as follows.

In step S310, the controller 210 determines whether or not the identification information Di in the semiconductor memory 352 of the new ink cartridge 300 is the identification information different from the identification information Di corresponding to the same print setting as the print setting already made. When the identification information Di in the semiconductor memory 352 is the identification information different from the identification information Di corresponding to the same print setting as the print setting already made, the processing ends. In the other cases, the processing proceeds to step S320.

In step S320, the controller 210 determines the information indicated by the identification information Di. When the information indicated by the identification information Di is area A, the processing proceeds to step S500a. When the information indicated by the identification information Di is area B, the processing proceeds to step S500b. When there is no identification information Di in the semiconductor memory 352, the processing proceeds to the printing that has been performed out of the steps S500a and S500b. By configuring the controller 210 in this manner, when an ink cartridge 300 that does not store identification information Di in the semiconductor memory 352 is attached to the printer 200 after the print setting is made, suitable printing is performed.

(5) In the above embodiments, the printer is a printer that discharges ink to form a printed material (refer to FIG. 1). However, the printer may be the other apparatuses, for example, an apparatus that produces an electronic device with a material discharged from a nozzle, or the like.

### 4.2 Other Second Embodiment

In the first and the second embodiments, the identification information Di is set in accordance with an area where the ink cartridge 300 is sold, a so-called “destination” (refer to FIG. 5 and FIG. 7). That is to say, an assumed user group assumed to be used is a user group corresponding to an area. However, the identification information Di may be the information corresponding to a specific user Us who requested special ink as in the third embodiment. In addition, it is possible to set the identification information Di for a user group corresponding to an environmental climate in which the printer is used, such as a temperate climate, a tropical climate, a polar climate, or the like. Further, the identification information Di may be set in accordance with a user group who uses a printer in a specific environment, such as a high-altitude area, an enclosed environment with low atmospheric pressure, a zero gravity environment, or the like.

### 4.3 Other Third Embodiment

(1) In the third embodiment, the identification information Di is the information corresponding to the user Us who requested creation of special ink (refer to FIG. 9). However, the identification information may be the information corresponding to a user other than the user who requested creation of specific ink, and may be a user to whom the specific ink is sold.

(2) In the above embodiments, the printer 200 performs print setting in accordance with the identification information Di in the ink cartridge 300. However, a cartridge having identification information may be a cartridge other than an ink cartridge. For example, a cartridge having identification information may be a toner cartridge containing toner. In addition, a cartridge having identification information may be a drum cartridge including a photosensitive drum. However, it is desirable that a cartridge having identification information include a part having a shorter use period compared with the printer 200, that is to say, a part having a so-called short life, or include a material consumed by being used. In this regard, in this specification, a material having a short life compared with a printer, and a material consumed by being used are referred to as “consumables”.

### 4.4 Other Fourth Embodiment

In the above embodiments, when the identification information Di is the information read from the semiconductor memory 352 of the ink cartridge 300 attached to the printer 200 from the second time onwards, the print setting in accordance with the identification information Di is not performed (refer to steps S220 in FIGS. 5 and S222 in FIG. 7). However, the print setting may be performed in accordance with the identification information read from the storage section of the cartridge attached to the printer from the second time onwards. In such a situation, for example, it is desirable that new print setting be performed when the identification information of all the cartridges attached to individual holders of the printer are identical.

### 4.5 Other Fifth Embodiment

In the print setting of the embodiments described above, when a new ink cartridge 300 is attached to the printer 200 in a state in which the print setting is already made, and the identification information Di in the semiconductor memory 352 of the new ink cartridge 300 corresponds to a print setting different from the print setting Sp already made, the processing ends. Accordingly, in such a case, printing is not performed in a state in which a new ink cartridge 300 is attached to the printer 200.

However, in such a case, it is possible to issue a warning to a user via the user interface of the printer, and to end the processing after that. In addition, it is possible to issue a warning to a user via the user interface of the printer, and to perform printing when an instruction to perform printing is received from the user.

### 5. Still Other Embodiments

The present disclosure is not limited to the embodiments described above, and it is possible to realize the present disclosure in various modes without departing from the spirit or scope of the disclosure. For example, it is possible to realize the present disclosure in the following modes. The technical characteristics in the embodiments described above corresponding to the technical characteristics described in the following embodiments may be suitably replaced or combined to solve a part of or all of the problems described in the present disclosure, or to achieve a part of or all of the advantages described in the present disclosure. In addition, unless the technical characteristics are described as necessary characteristics in this specification, it is possible to suitably delete the technical characteristics. In addition, a description has been given in the present embodiments of a so-called on-carriage type printer in which the ink cartridges IC1 to IC4 are mounted on the carriage 20 (refer to FIG. 1). However, a printer to which the disclosed technique is applied may be a printer as long as a printer in which a circuit substrate is implemented, and may be a printer in which an ink cartridge is mounted on a part of the printer other than a carriage, a so-called off-carriage type printer or an ink pack type printer.

(1) According to an aspect of the present disclosure, there is provided a printing system. The printing system includes a printer and a cartridge to be attached to the printer in a replaceable manner. The cartridge includes a storage section storing identification information corresponding to an assumed user group assumed to use the cartridge. The printer is configured to perform print setting, and the print setting is performed in accordance with the identification information in the storage section in a state in which the cartridge is attached to the printer. With this configuration, when a printer is not coupled to a personal computer, the print setting in accordance with an assumed user group assumed to be a user is performed for the printer.

(2) In the above printing system, the identification information may be set in accordance with an area where the cartridge is sold. With this configuration, when a printer is not coupled to a personal computer, the print setting in accordance with the destination of the printer is performed for the printer.

(3) In the above printing system, one or more of a plurality of cartridges configured to be attached to the printer may be sold only for a specific user, and the identification information stored in the storage section of the one or more of the plurality of cartridges may be information corresponding to the specific user. With this configuration, when a cartridge adjusted in accordance with a request from a specific user is sold to the specific user, the print setting in accordance with the adjusted cartridge is performed for the printer.

(4) In the above printing system, the printer may perform the print setting in accordance with the identification information read first from the storage section of the cartridge attached to the printer, and may not perform the print setting in accordance with identification information read from the second time onwards from the storage section of the cartridge attached to the printer. With this configuration, when a user mistakenly attaches a cartridge not sold in the area after the user started using the printer, the print setting for the printer is not overwritten.

(5) In the above printing system, when a new cartridge is attached to the printer in a state in which the print setting was already made, and identification information in the storage section of the new cartridge corresponds to a print setting different from the print setting already made, the printer may not perform printing in a state in which the new cartridge is attached to the printer. With this configuration, it is possible to prevent the situation in which a cartridge different from a cartridge assumed in the print setting for the printer is used, and the printing is performed, thereby the quality of a print result is deteriorated.

It is possible to realize the present disclosure in various modes other than a printing system. For example, it is possible to realize the present disclosure in a liquid discharge apparatus, a liquid discharge system, and a control method of a liquid discharge apparatus, a setting method for a liquid discharge apparatus, a computer program that realizes those methods, a non-transitory storage medium storing the computer program, and the like.

What is claimed is:

1. A printing system comprising:
a printer; and
a cartridge to be attached to the printer in a replaceable manner, wherein
the cartridge includes a storage section storing identification information corresponding to an assumed user group assumed to use the cartridge,
the printer is configured to perform print setting, and
the print setting is performed in accordance with the identification information in the storage section in a state in which the cartridge is attached to the printer.

2. The printing system according to claim 1, wherein
the identification information is set in accordance with an area where the cartridge is sold.

3. The printing system according to claim 1, wherein
one or more of a plurality of cartridges configured to be attached to the printer are sold only for a specific user, and
the identification information stored in the storage section of the one or more of the plurality of cartridges is information corresponding to the specific user.

4. The printing system according to claim 1, wherein
the printer performs the print setting in accordance with the identification information read first from the storage section of the cartridge attached to the printer, and does not perform the print setting in accordance with identification information read from a second time onwards from the storage section of the cartridge attached to the printer.

5. The printing system according to claim 4, wherein
when a new cartridge is attached to the printer in a state in which the print setting was already made, and identification information in the storage section of the new cartridge corresponds to a print setting different from the print setting already made, the printer does not perform printing in a state in which the new cartridge is attached to the printer.
